(19) United States
(12) Patent Application Publication
(10) Pub. No.: US 2011/0246701 A1
(43) Pub. Date: Oct. 6, 2011

(54) STORAGE APPARATUS AND ITS DATA CONTROL METHOD

(75) Inventors: Yoshiki Kano, Yokohama (JP); Sadahiro Sugimoto, Kawasaki (JP); Akira Yamamoto, Sagamihara (JP); Akihiko Araki, Yokohama (JP); Masayuki Yamamoto, Sagamihara (JP)

(73) Assignee: HITACHI, LTD., Tokyo (JP)

(21) Appl. No.: 12/527,441

(22) PCT Filed: Mar. 24, 2009
(86) PCT No.: PCT/JP2009/056421

§ 371 Date: Aug. 17, 2009

(51) Int. Cl. G06F 12/00

(52) U.S. Cl. 711/103; 711/E12.008

(57) ABSTRACT

Efficient leveling among a plurality of FMPKs 130 including a newly added or replaced FMPK 130. When a storage controller 110 lacks free blocks in real FMPKs 130 and any FMPK 130 of the real FMPKs 130 and an added substitute FMPK 130 are selected as leveling object devices, if the attribute of a block in the real FMPK 130 belonging to the leveling object devices is “Hot,” data larger than a threshold value from among data belonging to that block is migrated to a block in the substitute FMPK 130; or if the attribute of a block in the real FMPK 130 belonging to the leveling object devices is “Cold,” data smaller than the threshold value from among data belonging to that block is migrated to a block in the substitute FMPK 130.

### TECHNICAL FIELD

The present invention generally relates to a leveling processing technique for data stored in flash memories constituting storage media for a storage apparatus.

### BACKGROUND ART

When rewriting a flash memory, it is necessary to first perform the operation called “erasing” of data in blocks, which are memory units for the flash memory, and then rewrite data in the blocks. Each block has a limited life cycle for this erase operation due to physical limitations, and the limited number of erases is approximately 5,000 times for a Multi Level Cell (MLC) type flash memory and approximately 100,000 times for a Single Level Cell (SLC) type memory.

When rewriting data in each block in the flash memory, the number of erases varies among different blocks and, therefore, the flash memory cannot be used efficiently. There is a technique called “wear leveling” to equalize this imbalance. From among a variety of wear leveling systems, a representative wear leveling system is called “Hot-Cold (HC) wear leveling” for switching data between those in “Hot” blocks whose number of erases is large, and those in “Cold” blocks whose number of erases is small (see Non-patent Document 1).

In these wear leveling systems, data in flash memory packages equipped with a plurality of flash memory blocks are leveled.

Furthermore, a wear leveling system in which a plurality of flash memory modules is treated as one group in a storage apparatus is suggested (see Patent Document 1). In this system, the above-described wear leveling is conducted by treating a plurality of flash memory modules as a group.

### [Related Art Documents]

### [Patent Document 1] Japanese Patent Application Laid-Open (Kokai) Publication No. 2007-265265

[Non-patent Document 1] On efficient Wear-leveling for Large Scale Flash Memory Storage System http://www.cis.nctu.edu.tw/˜|pchang/papers/crm_sac07.pdf

### DISCLOSURE OF THE INVENTION

If a flash memory module (flash memory package) in the system described in Patent Document 1 fails and the faulty flash memory module is replaced with a new flash memory module, when blocks with a small number of erases are selected as wear leveling object blocks from flash memory modules, there is a possibility that selected blocks to be wear-leveled may be concentrated in flash memories of the new flash memory module and, as a result, data in the flash memory modules after the replacement may not be sufficiently leveled.

In other words, when a flash memory module is replaced in or added to a plurality of flash memory modules in the conventional art, the life of flash memory may vary among different flash memory modules due to imbalance of the number of erases.

The present invention was devised in light of the problem of the conventional art described above, and it is an object of the invention to provide a storage apparatus and its data control method enabling efficient leveling among a plurality of flash memory packages including a newly added substitute flash memory package.

In order to achieve the above-described object, the present invention is characterized in that the property of data in a plurality of flash memory packages is treated as an attribute and the data is migrated between the flash memory packages based on that attribute to avoid concentration on blocks selected to be leveled in the plurality of flash memory packages including a newly added substitute flash memory package.

### EFFECT OF THE INVENTION

The present invention can efficiently perform leveling among a plurality of flash memory packages including a newly added substitute flash memory package.

### BRIEF DESCRIPTION OF THE DRAWINGS

FIG. 1 is a configuration diagram illustrating the physical configuration of a storage apparatus and the physical configurations of apparatuses connected to the storage apparatus according to an embodiment of the present invention;

FIG. 2 is a configuration diagram illustrating the logical configuration of the storage apparatus and the logical configurations of the apparatuses connected to the storage apparatus according to the embodiment;

FIG. 3 is a configuration diagram of a PDEV-FMPK table showing the correspondence relationship between flash memory packages and physical devices that are management units for the flash memory packages according to the embodiment;

FIG. 4 is a configuration diagram of a PDEV format table for managing flash memory blocks in PDEVs that are management units for the flash memory packages according to the embodiment;

FIG. 5 is a configuration diagram of a column device table that defines the range of data migration between FM and PK when exchanging or adding packages according to the embodiment;

FIG. 6 is a configuration diagram of a RAID group table showing PDEV groups to which RAID protection is provided according to the embodiment;

FIG. 7 is a configuration diagram of an L_SEG-P_BLK table showing the correspondence relationship between storage areas in logical devices (LDEVs) and blocks in PDEVs according to the embodiment;

FIG. 8 is a configuration diagram of a mapping table showing the relationship between logical units (LU) and ports for connection between logical devices and an external host according to the embodiment;

FIG. 9 is a flowchart for explaining an initialization process operated by a storage maintenance person for the storage apparatus according to the embodiment;

FIG. 10 is a flowchart for explaining processing operated by a storage maintenance person or an administrator for creating an LDEV in the storage apparatus according to the invention;

FIG. 11 is a flowchart for explaining the operation to write data to an FMPK according to the embodiment;

FIG. 12 is a flowchart for explaining the operation to read data from an FMPK according to the embodiment;

FIG. 13 is a flowchart for explaining the operation to allocate a new block according to the embodiment;

FIG. 14 is a flowchart for explaining the operation to migrate data between packages according to the embodiment;

FIG. 15 is a diagram illustrating a management GUI according to the embodiment;

FIG. 16 is a diagram for explaining the outline of the embodiment;

FIG. 17 is a flowchart for explaining post-processing on blocks according to the embodiment; and

FIG. 18 is a configuration diagram of a WL (Wear Leveling) object block list when performing wear leveling according to the embodiment.

### BEST MODE FOR CARRYING OUT THE INVENTION

According to the present embodiment, the property of data in a plurality of flash memory packages is treated as an attribute and data is migrated between the flash memory packages based on that attribute of the data in order to avoid concentration of selected blocks in the plurality of flash memory packages including a newly added substitute flash memory package when performing leveling.

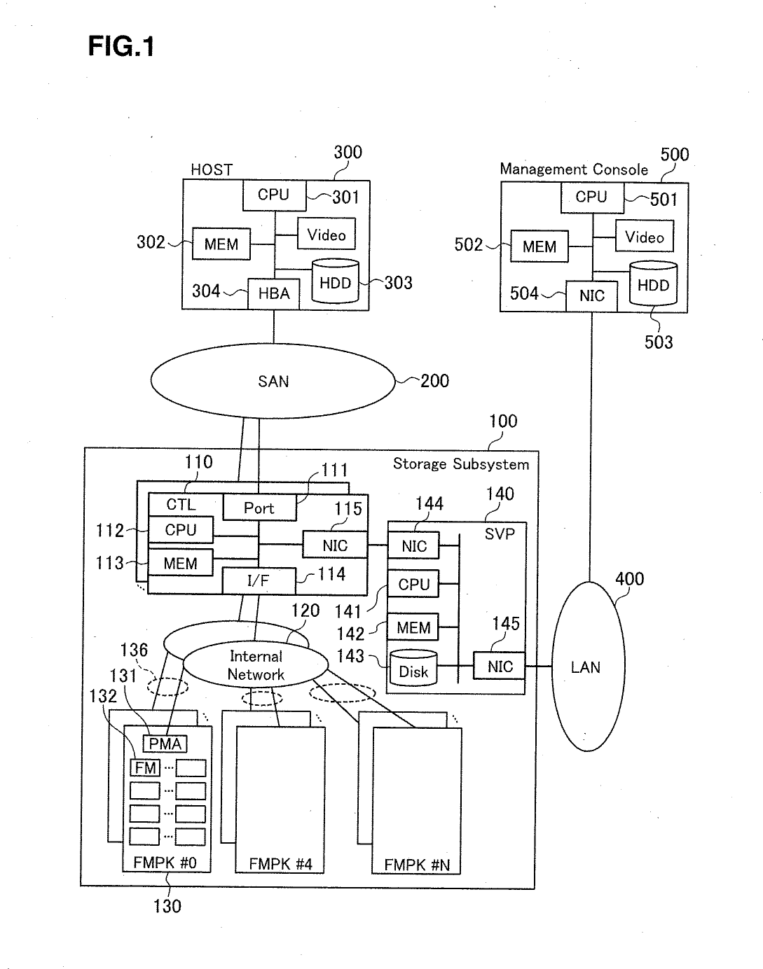

FIG. 1 shows the physical configuration of a storage apparatus and the physical configurations of apparatuses connected to the storage apparatus according to this embodiment.

A storage apparatus 100 serving as a storage subsystem is constituted from a plurality of storage controllers 110, internal bus networks 120, flash memory packages 130, and a service processor SVP (Service Processor) 140.

The storage controller 110 is constituted from a channel I/F 111 for connection to a host 300 via, for example, Ethernet (IBM's registered trademark) or Fibre Channel, a CPU 112 (Central Processing Unit) for processing I/O (inputs/outputs), a memory (MEM) 113 for storing programs and control information, an I/F 114 for connection to a bus inside the storage subsystem, and a network interface card (NIC) 115 for connection to the service processor 140. Incidentally, PCI-Express is used as the I/F 114 in this embodiment, but an I/F such as SAS (Serial Attached SCSI) or Fibre Channel, or a network such as Ethernet may be used as the I/F 114.

The internal bus network 120 is constituted from a switch that can be connected to, for example, PCI-Express. Incidentally, a bus-type network may be used as the internal bus network 120, if necessary.

Each flash memory package (hereinafter referred to as the “FMPK”) 130 is constituted from a plurality of flash memories 132 and a flash memory adapter (FMA) 131 for controlling access to data in the flash memories 132 based on access from the internal I/F 114. This FMPK 130 may be a flash memory package that make memory access, or a flash memory package like a Solid State Disk (SSD) that has a disk I/F for, for example, Fibre Channel or SAS.

The service processor (SVP) 140 loads programs that should be loaded to the storage controller 110 to the storage controller 110, performs initialization of the storage system, and manages the storage subsystem. This service processor 140 is constituted from a processor 141, a memory 142, a disk 143 for storing an OS (Operating System) and a microcode program for the storage controller 110, a network interface card (NIC) 144 for connection to the storage controller 110, and a network interface card (NIC) 145 such as Ethernet for connection to an external management console (management console) 500.

This storage apparatus 100 is connected to the host 300 via a SAN (Storage Area Network) 200 and is also connected to the management console 500 via a LAN (Local Area Network) 400.

The host 300 is a server computer and contains a CPU 301, a memory (MEM) 302, and a disk (HDD) 303. The host 300 also has a host bus adapter (HBA) 304 for, for example, SCSI (Small Computer System Interface) data transfer to/from the storage apparatus 100.

The SAN 200 uses a protocol according to which SCSI commands can be transferred. For example, protocols such as Fibre Channel, iSCSI, SCSI over Ethernet, or SAS can be used. In this embodiment, a Fibre Channel network is used.

The management console 500 is a server computer and contains a CPU 501, a memory (MEM) 502, and a disk (HDD) 503. The management console 500 also has a network interface card (NIC) 504 capable of communicating with the service processor 140 according to TCP/IP (Transmission Control Protocol/Internet Protocol). A network enabling communications between the server and a client such as an Ethernet network can be used as the network interface card (NIC) 504.

The LAN 400 operates according to the IP (Internet Protocol) protocol such as TCP/IP and is connected to the network interface card (NIC) 145 using a network, such as an Ethernet network, enabling communications between the server and a client.

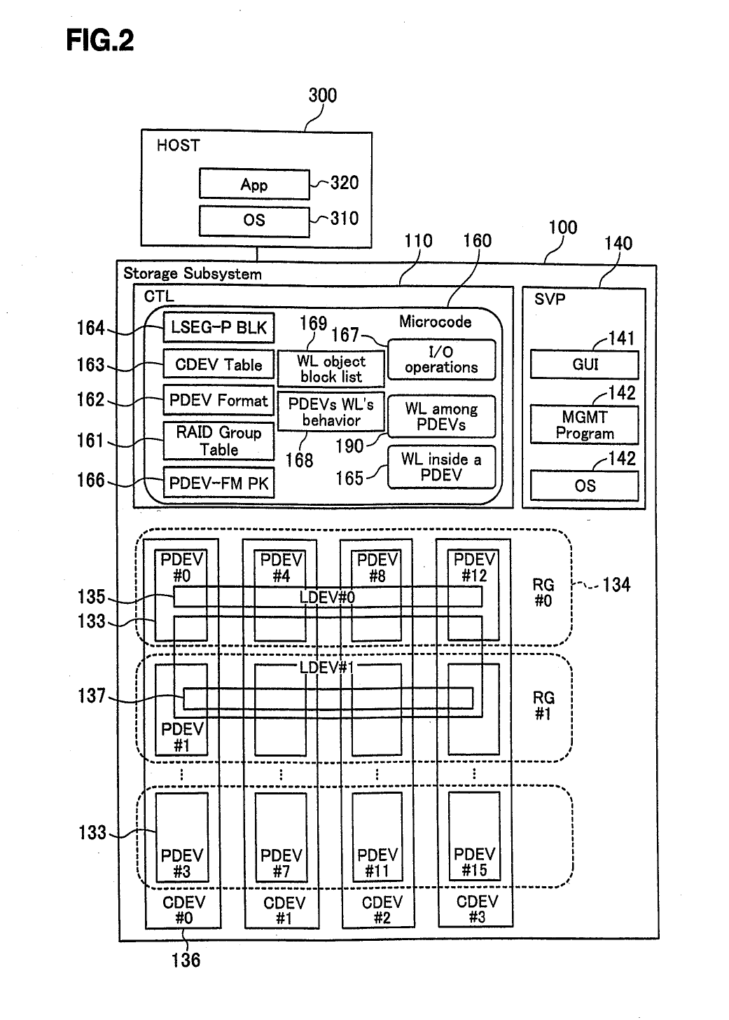

FIG. 2 shows the logical configuration of the storage apparatus and the logical configurations of the apparatus connected to the storage apparatus according to this embodiment.

The storage controller 110 executes the microcode program 160 provided by the service processor (SVP) 140. The microcode program 160 is provided by a maintenance person transferring a memory medium belonging to the service processor (SVP) 140 such as a CD-ROM (Compact Disc Read only Memory), a DVD-ROM (Digital Versatile Disc—Read only Memory), or a USB (Universal Serial Bus) memory to the service processor (SVP) 140.

In this situation, the storage controller 110 constitutes a leveling processing unit for managing data in each block of a plurality of FMPKs 130 according to the microcode program 160 and performs leveling processing on data in blocks belonging to leveling object devices.

The microcode program 160 has, as management information, a PDEV-FMPK table 166 showing the correspondence relationship between flash memory packages (hereinafter referred to as “FMPK”) and physical devices which are management units for FMPKs (hereinafter referred to as “PDEV”), a RAID group table 161 that defines data protection units for PDEV 133 groups, a PDEV format table 162 that defines a data area and a user area for flash memories existing in PDEVs, a column device (hereinafter referred to as “CDEV”) table 163 that defines the range of wear leveling for PDEV 133 groups, an LDEV SEG-PDEV BLK mapping table (referred to as the “L_SEG-P_BLK mapping table”) 164 showing the mapping relationship between address spaces in LDEVs and address spaces in PDEVs, an inter-PDEV wear leveling behavior bit 168 showing the types of wear leveling control behaviors, and a WL (Wear Leveling) object block list 169 showing a list of data migration object blocks when performing wear leveling among FMPKs; and the microcode program 160 also has control information in the memory for the storage controller 110.

Furthermore, the microcode program 160 has an I/O processing unit (I/O operations) 167 as a processing unit, an intra-PDEV wear leveling processing unit (WL inside PDEV) 165 for performing wear leveling processing (which may also be called “smoothing” or “leveling processing”) on the number of erases among flash memory blocks within PDEV 133, and an inter-PDEV wear leveling processing unit (WL among PDEVs) 190 for performing wear leveling processing on the number of erases of flash memories among PDEVs 133 defined by CDEVs 136; and the microcode program 160 executes the above-described processing whenever necessary. Incidentally, the details of the processing will be explained later.

Besides the processing described above, the microcode program 160 may perform processing which the storage apparatus 100 should be in charge of, for example, for managing the configuration of the storage apparatus 100 and protecting data in Redundancy Array of Independent Disks (RAID).

The microcode program 160 manages, for example, FMPKs 130 as follows: the microcode program 160 first manages logical storage areas for flash memories 132 belonging to the FMPKs 130, using units called “PDEVs” 133 which are logical management units; and the microcode program 160 constructs a plurality of RAID groups (RG) 134 out of a plurality of PDEVs 133 and protects data in the flash memories 132 in each RG. A stripe line 137 extending across a plurality of PDEVs 133 in a decided management unit (for example, 256 KB) can be used as a unit for managing data.

The stripe line 137 is a data migration unit when performing wear leveling within a PDEV 133 or among PDEVs 133 as described later. Specifically speaking, when wear leveling is performed among RGs, data is migrated in stripe lines. Furthermore, when performing wear leveling among PDEVs 133 as described later, CDEVs 136 that define PDEV 133 groups are defined. When this happens, the CDEVs 136 constitute the leveling object devices.

The microcode program 160 manages data for each RG and performs wear leveling in the CDEV 136, thereby protecting storage areas and improving availability. A plurality of logical devices (hereinafter referred to as “LDEV”) 135 that are logical storage spaces are prepared on the CDEVs 135 in the storage apparatus 100. Each LDEV 135 is constructed across a plurality of CDEVs 136. Each LDEV 135 serving as a logical unit for the host 300 performs SCSI read and write processing for reading/writing data from/to the host 300, using the WWN (World Wide Name) and LU number assigned to the relevant LDEV 135 by the microcode program 160.

The SVP 140 has an OS 142 as well as a management program 142 and a GUI (Graphical User Interface) 141 that are used by the maintenance person to give operational instructions to the microcode program 160.

After the host 300 uses an OS 310 to recognize volumes of logical units LU mentioned above and then creates a device file, the host 300 formats the device file. Subsequently, the device file can be accessed by applications 320. A common OS such as UNIX (a registered trademark of The Santa Cruz Operation, Inc.) or Windows (Microsoft's registered trademark) can be used as the OS 310.

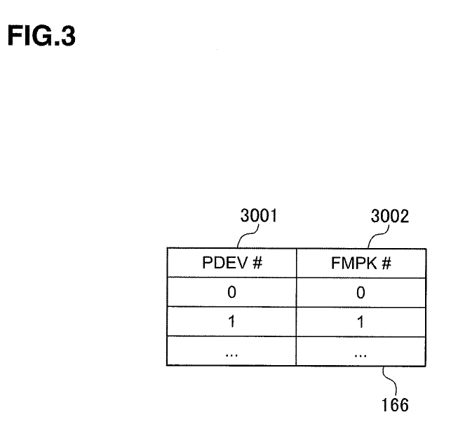

FIG. 3 is a PDEV-FMPK table 166 showing the correspondence relationship between flash memory packages (hereinafter referred to as “FMPK”) and physical devices (PDEV) which are management units for the FMPKs according to this embodiment. The PDEV-FMPK table 166 is constituted from a “PDEV number (PDEV#)” field 3001 and an “FMPK number (FMPK#)” field 3002. The FMPK number in this embodiment corresponds to a slot number of the storage apparatus 100 into which the relevant FMPK 130 is inserted; however, the FMPK number may be determined in a different way.

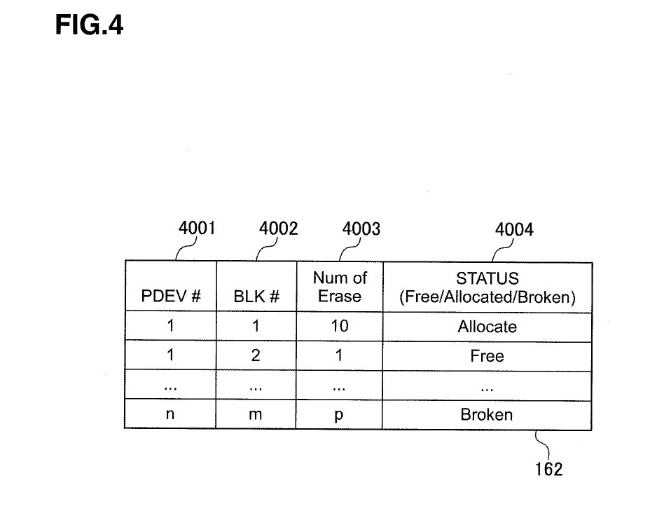

FIG. 4 is a PDEV format table 162 for managing flash memory blocks in PDEVs 133 which are logical management units for the flash memory adapter FMA 131 according to this embodiment. The PDEV format table 162 is constituted from a “PDEV number (PDEV#)” field 4001 to which the relevant block belongs, a “block number (BLK#)” field 4002 in the relevant PDEV 133, a field storing the “number of erases of each block (Num of Erases)” 4003, and a field storing three types of the “current allocation status (Status)” 4004, i.e., “Free,” “Allocated,” or “Broken (Faulty) .”

After the microcode program 160 executes processing for erasing data in a block prior to rewriting the block, the number of erases is recorded as an accumulated count in the “number of erases” field 4003,.

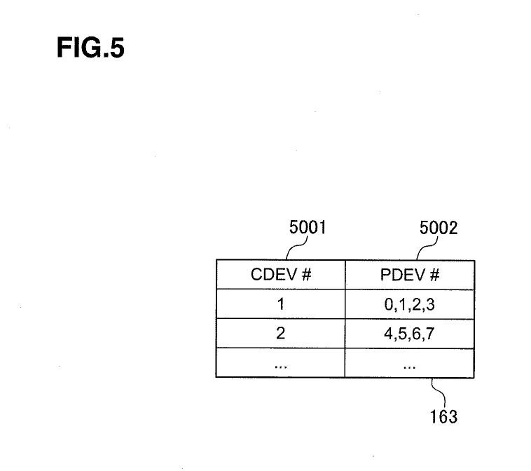

FIG. 5 is a column device table 163 that defines the range of data migration between FMPKs 130 when replacing or adding an FMPK 130 in this embodiment. The column device table 163 is constituted from a “CDEV number (CDEV#)” field 5001 indicating a CDEV 136 group and a “PDEV number (PDEV#)” field 5002.

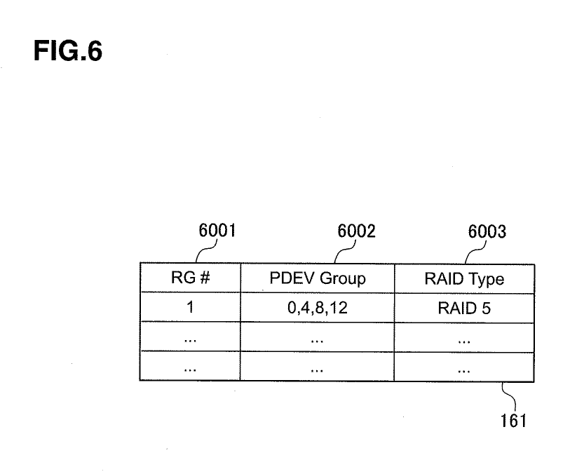

FIG. 6 is a RAID group table 161 showing PDEV groups to be protected by the RAID according to this embodiment. The RAID group table 161 is constituted from an “RG number (RG#)” field 6001, a “PDEV group” field 6002 indicating PDEV groups to be protected by the RAID, and a “RAID protection type” field 6003 indicating the RAID type for the relevant RG. Although “RAID 5” is indicated as the RAID protection type in this embodiment, other types such as RAID 1, RAID 2, RAID 3, RAID 4, or RAID 6 may be selected.

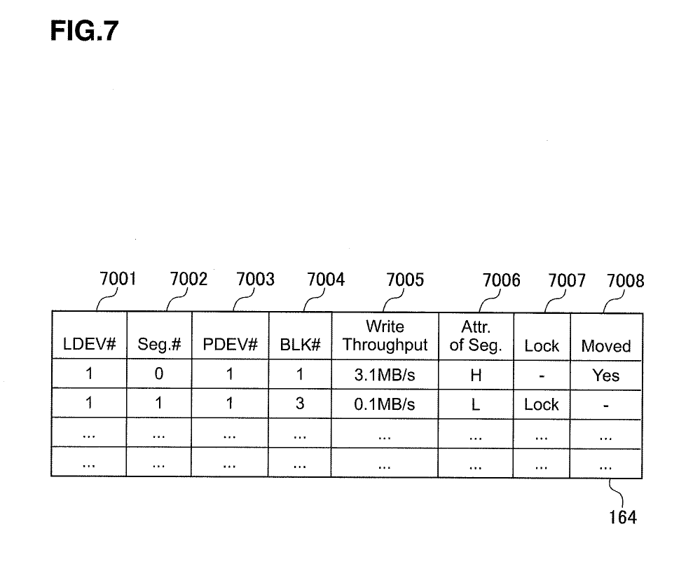

FIG. 7 is an LDEV segment—PDEV block management table (L_SEG-P_BLK table) 164 showing the correspondence relationship between storage spaces in LDEVs 135 and blocks in PDEVs 133 according to this embodiment. The L_SEG-P_BLK table 164 is constituted from a “device number (LDEV#)” field 7001, a “segment number (Seg. #)” field 7002 indicating an address space in the relevant LDEV 135, a “physical device number (PDEV#)” field 7003 indicating a physical device to which the relevant block described below belongs, a “physical block number (BLK#)” field 7004 for the flash memory 132, a “block average write throughput (Write Throughput)” field 7005, a “segment attribute (Attribute of Segment)” field 7006 indicating the segment attribute (high access (H) or low access (L)) judged from the average write throughput, a “Lock” field 7007 in which the state of the relevant segment being locked when writing data to the relevant segment or performing the wear leveling on the relevant segment is indicated as “Locked,” and a “Moved” field 7008 in which “Yes” is stored when the segment has been moved between FMPKs 130 as a result of the write operation.

The size of a segment is equal to that of a block (for example, 256 KB) in a flash memory 132, but a segment may be constituted from a plurality of blocks. When determining the attribute of each segment 7006, the microcode program 160 periodically measures the write throughput of data belonging to segments (blocks) in each PDEV 133, calculates an average value of the maximum measured value and the minimum measured value, and determines this calculated average value to be a threshold value for the write access frequency.

If the measured value of the write throughput of data in each segment (block) is equal to or larger than the threshold value, the microcode program 160 recognizes the relevant segment (block) as a high-access segment (block) and gives the high access (H) attribute to that segment (block); or if the measured value of the write throughput of data in each segment (block) is smaller than the threshold value, the microcode program 160 recognizes the relevant segment (block) as a low-access segment (block) and gives the low access (H) attribute to that segment (block). As a result, the microcode program 160 records the high access (H) or the low access (L) in the “attribute” field 7006 in the mapping table 164.

The above-described method of determining the attribute 7006 is one example; and other methods may be used as long as data that is frequently accessed can be defined as “high-access” data and data that is not often accessed can be defined as “low-access” data. For example, the write throughput is used as frequency information in this embodiment; however, the number of erases per second for each block may be utilized as the frequency information. An average erase frequency may be calculated from the erase frequency, thereby determining whether the attribute is high-access or low-access. The initial state of the “Lock” field when creating an LDEV 135 may be set to “-” which means the relevant LDEV 135 is not locked at the time of allocation of the LDEV 135; and the initial state of the “Moved” field may be set to “-” which means the relevant segment has not been moved.

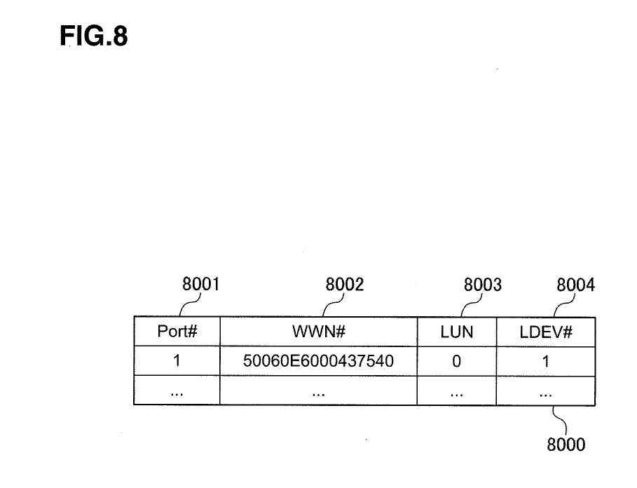

FIG. 8 is a mapping table 8000 indicating logical units (LU) and ports (Port) for connecting LDEVs 135 to the host 300 according to this embodiment. The mapping table 8000 is constituted from a “port number (Port #)” field 8001, a “World Wide Name (WWN) number (WWN#)” field 8002 storing the WWN number assigned to each port as a unique address in the SAN 200, an “LU number (LUN)” field 8003, and an “LDEV number (LDEV#)” field 8004 storing the number of the LDEV 135 as defined in the L_SEG-P_BLK table 164.

The configurations and the management information according to this embodiment have been described above.

Control and operations will be explained below, using the configurations and the management information described above.

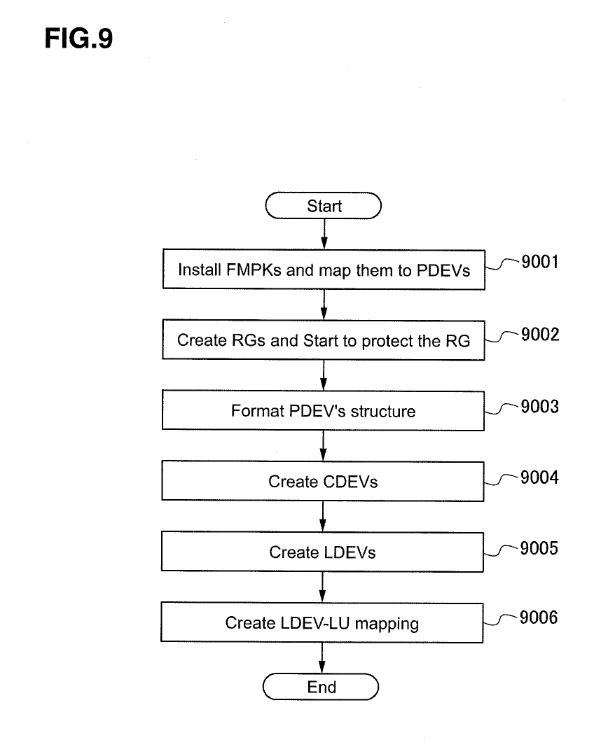

FIG. 9 shows an initialization process operated by a storage maintenance person for the storage apparatus 100 according to this embodiment.

The maintenance person first installs FMPKs 130 into slots provided in the storage apparatus 100 and then decides the correspondence relationship between the FMPKs 130 and PDEVs 133. The slot number is set as the PDEV number regarding the correspondence relationship between the FMPKs 130 and the PDEVs 133, and the relationship is stored in the PDEV-FMPK table 166 in FIG. 3 (step 9001).

Next, the maintenance person decides the RG number, selects PDEVs 133 to be included in RGs, and creates the RGs, using the management console 500. This relationship is stored in the RAID group table 161 (step 9002). The maintenance person formats the PDEVs 133. After formatting of the PDEVs 133 is completed, the microcode program 160 creates the PDEV format table 162 in FIG. 4 (step 9003). When creating the PDEV format table 162, the microcode program 160 manages all the blocks in the PDEVs 133 as being unused (Free) blocks (BLKs).

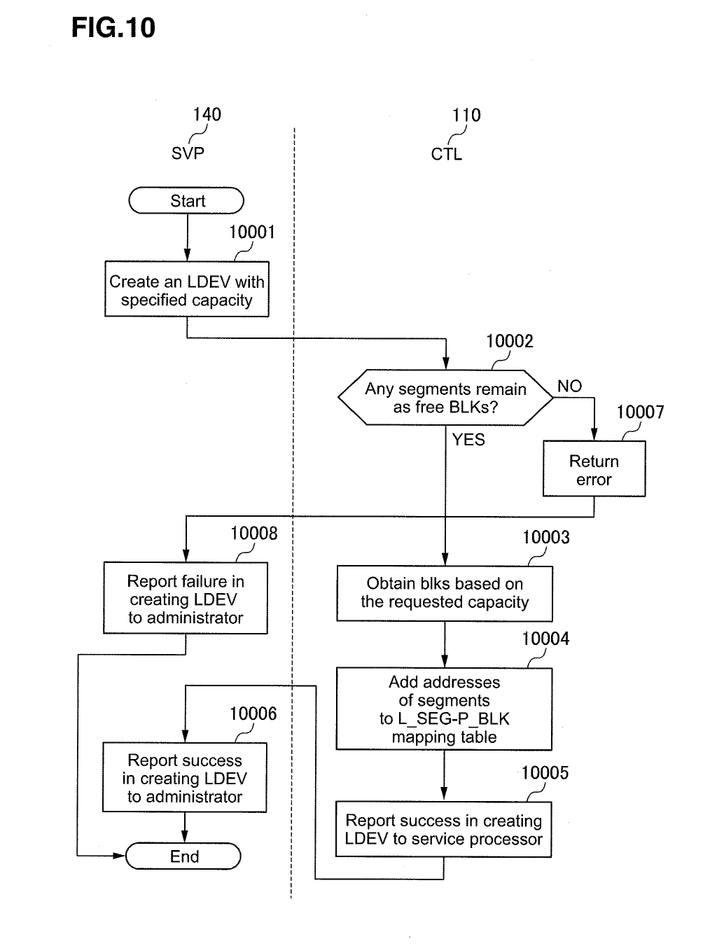

Subsequently, the maintenance person creates CDEVs belonging to a leveling object device for performing wear leveling in the PDEV 133 group (step 9004). This correspondence relationship is stored via the service processor SVP 140 in the column device table 163 in FIG. 5. Next, the maintenance person creates LDEVs out of the created CDEV 136 group (step 9005). Details of how to create LDEVs will be explained later with reference to FIG. 10.

Finally, the maintenance person creates an LDEV-LU mapping table as processing for disclosing the LDEVs 135 to the host 300 and records this correspondence relationship via the microcode program 160 in the mapping table 8000 in FIG. 8.

The initialization process operated by the maintenance person has been described above; however, the operation to create the LDEVs 135 (9005) and the operation to create the mapping table 8000 (9006) may be performed by an administrator who generally manages the storage system (hereinafter referred to as the “administrator”).

FIG. 10 shows processing operated by the storage maintenance person or the administrator for creating an LDEV 135 in the storage apparatus 100 according to the present invention. Regarding the creation of the LDEV 135, a volume is created by collecting the necessary capacity of free segments in a CDEV 136. Details of the procedure will be explained below.

Step 10001: the management program (142) of the service processor (SVP) 140 makes a request to the microcode program 160 to create an LDEV 135 with the capacity input by the maintenance person or the administrator.

Step 10002: the microcode program 160 checks, by referring to the PDEV format table 162 in FIG. 4, if the number of segments with the specified capacity (capacity/segment size) remains as free blocks. If step 10002 returns an affirmative judgment, the microcode program 160 proceeds to step 10003; or if step 10002 returns a negative judgment, the microcode program 160 proceeds to step 10007.

Step 10003: the microcode program 160 obtains blocks corresponding to the number of segments with the specified capacity and manages the obtained blocks by setting “Allocated” in the “Status” field 4004 in the table 162.

Step 10004: the microcode program 160 assigns an LDEV number to the obtained blocks, gives segment numbers to the allocated blocks, and adds them to the L_SEG-P_BLK mapping table 164 in FIG. 7.

Step 10005: the microcode program 160 notifies the service processor (SVP) 140 that the LDEV 135 was successfully created.

Step 10006: the service processor (SVP) 140 notifies the administrator via the GUI that the LDEV 135 was successfully created.

Step 10007: the microcode program 160 notifies the service processor (SVP) 140 that the creation of the LDEV 135 failed.

Step 10008: the service processor (SVP) 140 notifies the administrator via the GUI that the creation of the LDEV 135 failed.

Then, the above-described processing terminates.

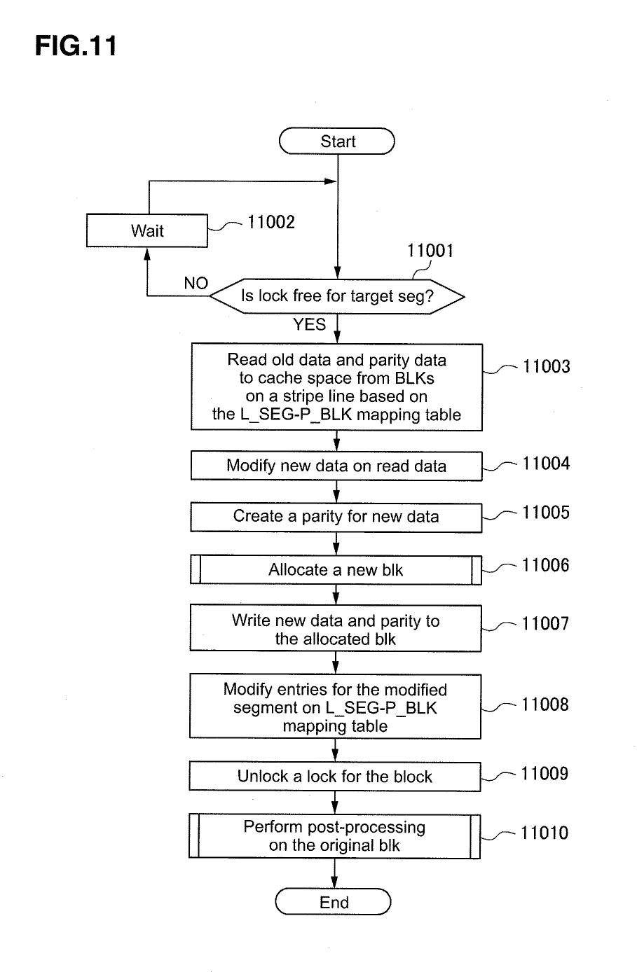

FIG. 11 shows the operation to write data to a PDEV 133 according to this embodiment. This processing is executed by the I/O processing unit 167. After receiving a write command from the host 300, the microcode program 160 stores the write command in a cache for the memory 113 and then writes the data to the PDEV 133 at the time of destaging or in response to the write command from the host 300. This operation will be explained below in the following steps.

Step 11001: the microcode program 160 obtains an access LBA of the target LU from a SCSI write command issued from the host 300. The microcode program 160 obtains the LDEV number 8004 from the mapping table 8000 in FIG. 8 and checks, based on the segment number in the LDEV number 7001 indicated by the L_{—SEG-P}_BLK mapping table 164 in FIG. 7, if the “lock” is not stored in the “Lock” field 7007 for the segment with the block number at the target address. If the “lock” is stored (i.e., the lock is not free), the microcode program 160 proceeds to step 11002. If the “lock” is not stored (i.e., the lock is free), the microcode program 160 proceeds to step 11003.

Step 11002: the microcode program 160 enters the wait state (Wait) for several microseconds.

Step 11003: the microcode program 160 reads old data and parity data from blocks on the same stripe line 137 based on the L_SEG-P_BLK mapping table 164.

Step 11004: the microcode program 160 updates the old data, which has been read, with new data.

Step 11005: the microcode program 160 creates new parity data from the updated data and the old parity data.

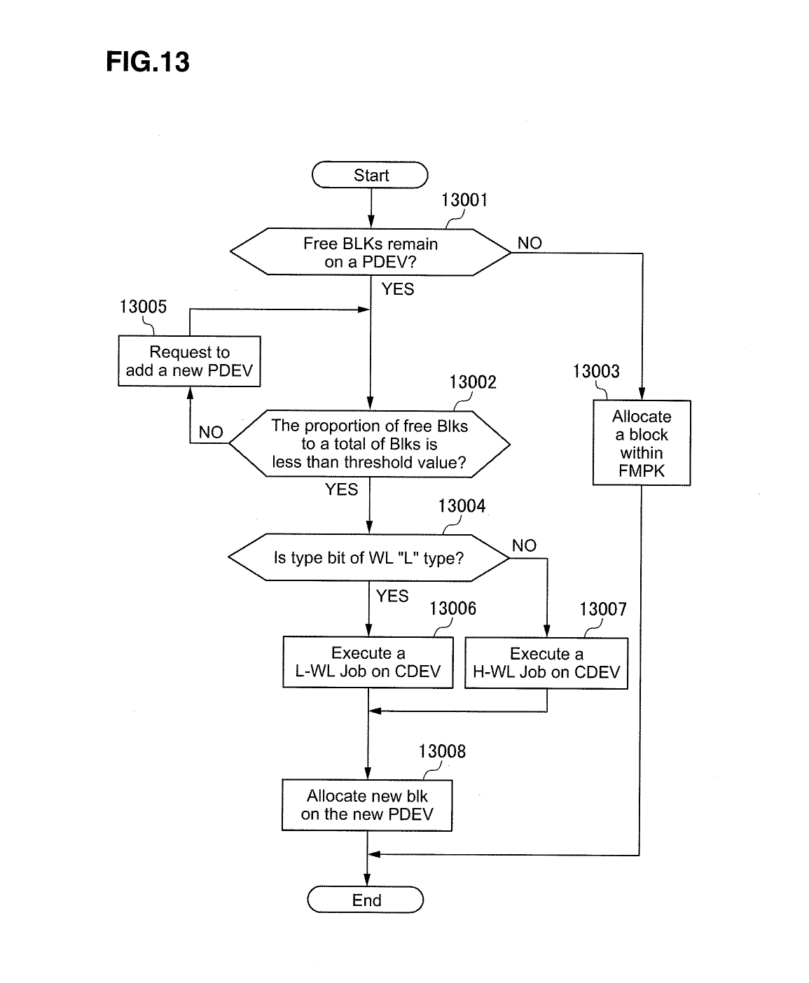

Step 11006: the microcode program 160 allocates a new block (BLK). When allocating the new BLK to a stripe line selected from stripe lines on the RAID, other corresponding BLKs are also moved to the same stripe line. Processing described later in detail with reference to FIG. 13 is executed in this step.

Step 11007: the microcode program 160 writes the new data and parity data to the allocated BLK.

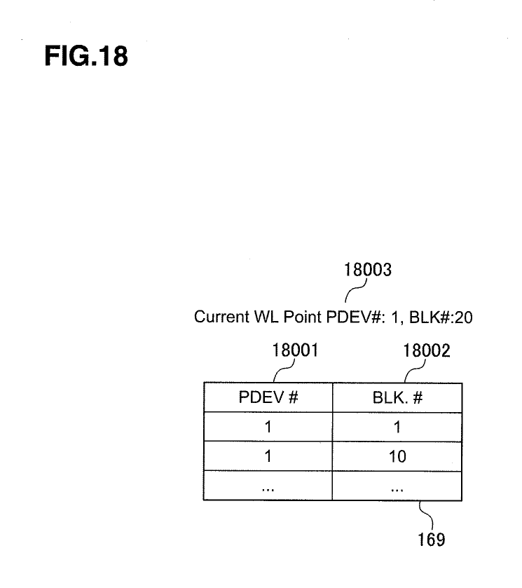

Step 11008: the microcode program 160 updates the L_SEG-P_BLK mapping table 164 so that the content of the segment updated in the L_SEG-P_BLK mapping table 164 will match the new block. The microcode program 160 also refers to the WL object block list in FIG. 18 and checks whether the old block number exists or not. If the old block number exists, the microcode program 160 marks the “Moved” field 7008 with “Yes” in the L_SEG-P_BLK mapping table 164.

Step 11009: the microcode program 160 unlocks the “lock” (7007).

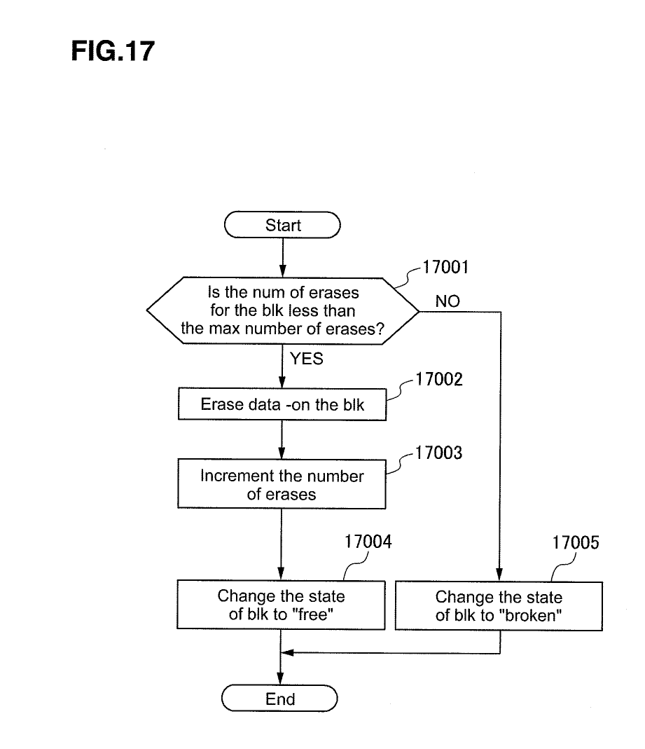

Step 11010: the microcode program 160 performs post-processing on the original block. Details of this post-processing will be explained below with reference to FIG. 17.

Then, the above-described processing terminates.

FIG. 17 is a flowchart illustrating the post-processing on a block according to this embodiment. The processing sequence is as follows:

Step 17001: the microcode program 160 checks, by referring to the “PDEV number” field 4001 and the “BLK number” field of the relevant block, if the number of erases (Num of Erases) 4003 is less than the maximum number of erases for the flash memory 132 of the relevant block (for examples, 5000 times in the case of MLC). If the number of erases is less than the maximum number of erases, the microcode program 160 proceeds to step 17002; or if the number of erases is equal to or more than the maximum number of erases, the microcode program 160 proceeds to step 17005.

Step 17002: the microcode program 160 deletes data in the block in the flash memory 132.

Step 17003: the microcode program 160 increments the number of erases 4003 by only +1.

Step 17004: the microcode program 160 changes the state of the relevant block to “Free.”

Step 17005: the microcode program 160 manages the relevant block by changing the state of the block to “Broken” which means the block cannot be used.

Then, the above-described processing terminates.

The processing shown in FIG. 17 can be also used for releasing an LDEV 135. When the administrator designates the LDEV number and gives a release instruction via the service processor (SVP) 140, it is possible to perform the release processing in FIG. 17 on all the BLKs 7004 with the corresponding LDEV number 7001.

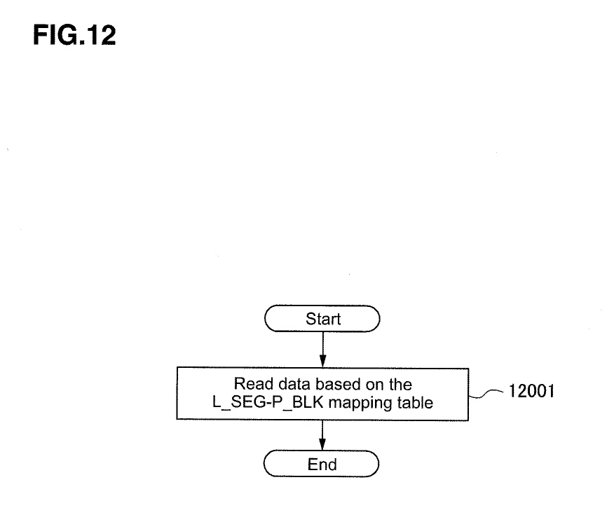

FIG. 12 shows the operation to read data according to this embodiment. This processing is executed by the I/O processing unit 167. As in the case of the operation to write data, the following operation is performed in order to read data from the cache for the memory 113 to a PDEV 133 when there is no data in the cache.

Step 12001: the microcode program 160 reads object data to the cache based on the L_SEG-P_BLK mapping table 164 in FIG. 7.

Then, the above-described processing terminates.

FIG. 13 is a flowchart for explaining the operation to allocate a new block according to this embodiment. This processing can be also used in step 10003 in FIG. 10 and in step 11006 in FIG. 11 when allocating a new BLK.

Details of the processing are as follows:

Step 13001: the microcode program 160 refers to the “Status” field in the PDEV format table 162 in FIG. 4 and calculates a proportion of the number of free BLKs to the total number of BLKs in a target PDEV 133 to which a new block is to be allocated (this processing may be performed periodically in advance). Then, in order to check if there is any free block BLK left in the FMPK 130, the microcode program 160 check if the above-described proportion is less than a specified threshold value or not. If the proportion is less than the threshold value, the microcode program 160 proceeds to step 13003; or if the proportion is not less than the threshold value, the microcode program 160 proceeds to step 13002. Incidentally, the threshold value used in this step may be decided by the administrator or the maintenance person or decided at the time of factory shipment.

Step 13002: the microcode program 160 refers to the column device table 163 in FIG. 5, refers to the “Status” field in the PDEV format table 162 in FIG. 4 regarding all the PDEVs 133 in the relevant CDEV 136, and calculates a proportion of the number of free BLKs to the total number of BLKs in the target PDEV 133 to which a new block is to be allocated. Then, in order to check if there is any free BLK left in the CDEV 136, the microcode program 160 check if the proportion of the number of free BLKs to the total number of BLKs is less than a specified threshold value (for example, 80%) or not. If the proportion is less than the threshold value, the microcode program 160 proceeds to step 13004; or if the proportion is not less than the threshold value, the microcode program 160 proceeds to step 13005.

In the above situation, the microcode program 160 proceeds to step 13005 because an increase in the number of free BLKs in other packages can be expected after adding a substitute FMPK 130 as a substitute for an already used and implemented real FMPK 130 and registering PDEVs 133 belonging to the added substitute FMPK 130. Incidentally, the threshold value used in step 13002 may be decided by the administrator or the maintenance person or decided at the time of factory shipment.

Step 13003: the microcode program 160 selects a block from PDEVs 133 in the FMPK 130. When selecting a block to perform wear leveling, an algorithm for block selection, such as Dual Pool in Non-patent Document 1, an HC algorithm, or other algorithms can be used.

Step 13004: the microcode program 160 refers to the behavior bit 168 indicating the type of wear leveling in the CDEV 136 and decides the wear leveling algorithm for this storage system. If the behavior bit 168 indicates the wear leveling of the low-access type (“L”), the microcode program 160 proceeds to step 13006; or if the behavior bit 168 indicates the wear leveling of the high-access type (“H”), the microcode program 160 proceeds to step 13007.

Step 13005: the microcode program 160 determines that there is no free BLK in the column device CDEV, and then makes a request for addition of a new PDEV 133 to the CDEV 136 to the administrator or the maintenance person via the service processor (SVP) 140, using, for example, a screen on the GUI, according to SNMP (Simple Network Management Protocol), or by mail.

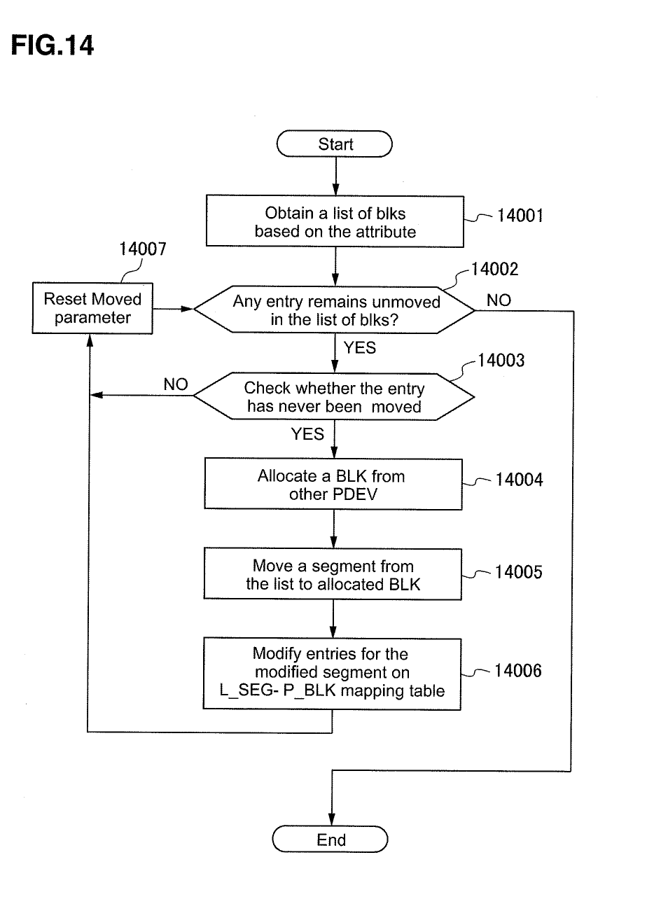

Step 13006: the microcode program 160 performs the low-access-type wear leveling in the CDEV 136 using asynchronous I/O, i.e., in the background. Details of the processing will be explained with reference to FIG. 14.

Step 13007: the microcode program 160 performs the high-access-type wear leveling in the CDEV 136 using asynchronous I/O, i.e., in the background. Details of the processing will be explained with reference to FIG. 14.

Step 13008: the microcode program 160 allocates a new BLK from free segments 162 in the PDEV 133 added in the PDEV format table 162 in FIG. 4.

Then, the above-described processing terminates.

Incidentally, the above flow illustrates the processing for allocation. However, free blocks in the CDEV 136 may be checked (step 13002) periodically in the background independently of this processing in order to promote addition of a new FMPK 130.

In this example, it is assumed that the storage controller 110 including the microcode program 160 serves as the leveling processing unit to execute all the processing. However, if the flash memory adapter (FMA) 131 for FMPKs 130 is configured so that it can manage free blocks in the PDEV format table 162 in FIG. 4, the flash memory adapter (FMA) 131 may manage free blocks in the PDEV in step 13001 and allocate a free block in response to a request for a new block from the microcode program 160 in step 13008.

FIG. 14 shows operations between packages according to this embodiment. This processing is executed by the I/O processing unit 167. This processing is the specific processing sequence in step 13007 in FIG. 13 for performing the low-access-type wear leveling or the high-access-type using asynchronous I/O.

Step 14001: the microcode program 160 refers to the column device table 163 in FIG. 5, refers to the “segment attribute” field 7006 in the L_SEG-P_BLK mapping table 164 in FIG. 7 with regard to all the PDEVs 136 in the relevant CDEV 136, and selects the type of the segment to be moved (high access “H” or low access “L”). Then, the microcode program 160 obtains a block group list relating to blocks 7004 of the relevant segment. The obtained list is constituted from the PDEV number (18001) and the BLK number (18002) as shown in the WL object list 169 in FIG. 18. A pointer 18003 indicating the BLK (block) in the PDEV 133 on which the wear leveling is currently being performed is given to the WL object block list 169. Incidentally, the type of the segment to be moved is judged by the behavior bit 168 indicating the type of wear leveling in the CDEV 136 as described above (the behavior bit 168 in terms of table information is the “Moved” field 7008 in the L_SEG-P_BLK mapping table 164).

Step 14002: the microcode program 160 checks if any block remains unmoved in the block group selected in step 14001. If there is any unmoved block, the microcode program 160 proceeds to step 14003; or if all the blocks have been moved, the microcode program 160 terminates the processing.

Step 14003: the microcode program 160 checks if the block to be moved has not already been moved, by checking whether the status of the “Moved” field 7008 in the L_SEG-P_BLK mapping table 164 in FIG. 7 is “Yes” or not, based on the PDEV number 7003 and the block number 7004. If “-” is stored in the “Moved” field, which means the relevant block has not been moved, the microcode program 160 proceeds to step 14004; or if “Yes” is stored in the “Moved” field, which means the relevant block has been moved, the microcode program 160 proceeds to step 14007.

Step 14004: the microcode program 160 allocates a destination block from a PDEV 133 added to store blocks.

Step 14005: the microcode program 160 migrates data of the block to be moved to the allocated destination block.

Step 14006: the microcode program 160 replaces the segment number 7004 of the segment, to which the source block belongs, in the L_SEG-P_BLK mapping table 164 in FIG. 7 with the segment number of the destination block.

Step 14007: the microcode program 160 resets the value in the “Moved” field 7008 to “-” in order to indicate that the operation on the object block has been completed, and then the microcode program 160 moves the pointer 18003, which is given to the WL object block list 169 shown in FIG. 18, to the next segment.

In this embodiment, it is assumed that the microcode program 160 executes all the processing. However, if the flash memory adapter (FMA) 131 for FMPKs 130 is configured so that it can manage free blocks in the PDEV format table 162 in FIG. 4, the flash memory adapter (FMA) 131 can change mapping of the segment in step 14006 and then changes the state of the relevant block to “free.”

The advantage of the low-access-type processing is that the number of free blocks in the PDEV which is the migration source increases and it is possible to further perform wear leveling using high-access-type data existing in the remaining segments.

The advantage of the high-access-type processing is that high-access-type data can be expected to be migrated together with write I/O by the host and, therefore, it is possible to reduce the number of I/O at the time of migration.

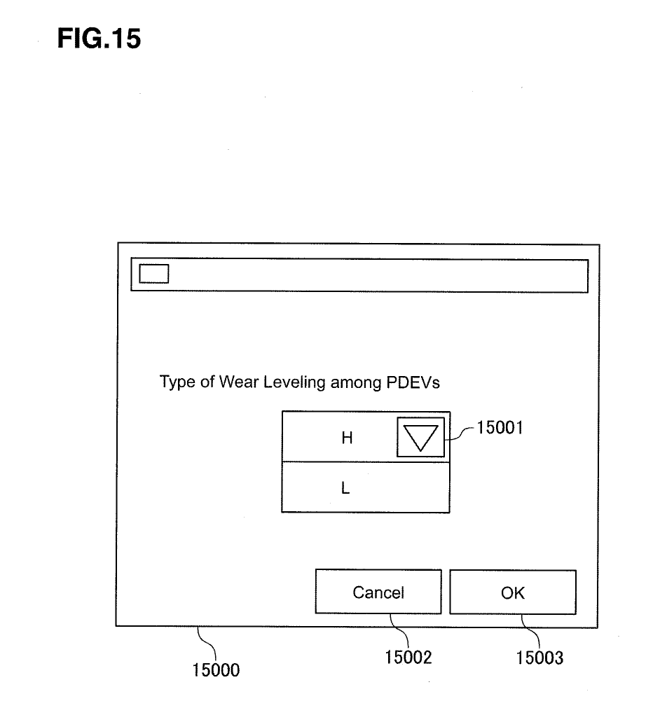

FIG. 15 shows a management GUI 15000 according to this embodiment. This processing is operated by the GUI processing unit for the service processor (SVP) 140. With the management GUI 15000, a pull-tag 15001 is used to set the type of wear leveling among PDEVs 133 to be applied to all CDEVs or the selected CDEV 136, and an OK button 15003 is used to decide the type of wear leveling. The content of this decision is stored in the wear leveling processing unit 190 for performing wear leveling among the PDEVs 133 and is used when performing wear leveling in a CDEV 136.

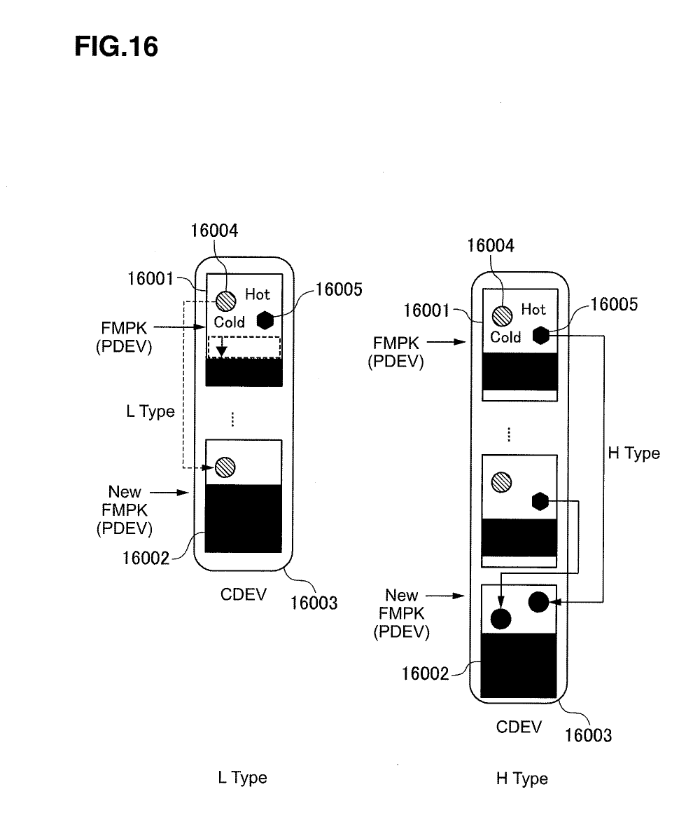

FIG. 16 is a diagram for explaining the outline of the operation to implement the content of this embodiment.

In the case of the low access type, low-access data in a block 16004 having the low access attribute in a physical device PDEV 16001 is migrated to an additional package (substitute package) 16002 and high-access data remains in the physical device PDEV 16001, so that the number of free blocks increases and the effect of wear leveling can be enhanced.

In the case of the high access type, high-access data in a block 16005 having the high access attribute in the physical device PDEV 16001 is migrated to the additional package (substitute package) 16002 and low-access data remains in the physical device PDEV 16001. As a result, it is possible to enhance the effect of wear leveling in the additional package 16002 and replace the package quickly.

According to this embodiment as described above, the storage controller 110 manages data in each block of a plurality of FMPKs 130 based on the attribute of the relevant block according to the microcode program 160 and performs the leveling processing on data in blocks belonging to the leveling object device(s).

The storage controller 110 can perform the leveling processing on data in blocks belonging to the leveling object device(s) by, for example, allocating a PDEV 133 with a small number of erases to an LDEV 135 with high write access frequency and allocating a PDEV 133 with a large number of erases to an LDEV 135 with low write access frequency.

The microcode program 160 measures the write access frequency of data in each block of the real FMPKs 130 which have been already used, gives a high access attribute to blocks containing data whose measured value of the write access frequency is larger than a threshold value, or gives a low access attribute to blocks containing data whose measured value of the write access frequency is smaller than the threshold value; and if the real FMPKs 130 lack free blocks, the microcode program 160 controls migration of data in each block based on the attribute of the data in each block of the real FMPKs 130, so that it is possible to efficiently perform the leveling among a plurality of FMPKs 130 including a newly added FMPK 130.

Specifically speaking, when the real FMPKs 130 lack free blocks and the microcode program 160 selects a CDEV 136 belonging to any FMPK 130 of the real FMPKs 130 and an added substitute FMPK 130 to be a leveling object device, and if the attribute of a block in the real FMPK 130 belonging to the leveling object device is the high access attribute, the microcode program 160 migrates data which is larger than a threshold value from among data belonging to that block, to a block in the substitute FMPK; or if the attribute of a block in the real FMPK 130 belonging to the leveling object device is the low access attribute, the microcode program 160 migrates data which is smaller than the threshold value from among data belonging to that block, to a block in the substitute FMPK 130; and as a result, it is possible to efficiently perform the leveling among a plurality of FMPKs 130 including a newly added FMPK 130.

According to this embodiment, it is possible to efficiently perform leveling among a plurality of FMPKs 130 including a newly added FMPK 130.

### INDUSTRIAL APPLICABILITY

The system according to the present invention constituted from a plurality of flash memory packages 130 where a flash memory packages 130 is added or replaced can be utilized for a storage system in order to equalize the imbalance in the number of erases not only within the packages, but also outside the packages.

1. A storage apparatus comprising:
a plurality of flash memory packages mounted on a chip, including real flash memory packages that are already set as flash memory packages containing a plurality of flash memories in which block groups (BLK), data memory units, are formed, and a substitute flash memory package that is a substitute for the real flash memory packages; and
a leveling processing unit for managing data in each block of the plurality of flash memory packages based on the attribute of the relevant block and executing leveling processing on data in blocks belonging to at least one leveling object device (from among devices constituting the plurality of flash memory packages;
wherein the leveling processing unit migrates data in a block of the real flash memory packages belonging to the leveling object device to a block in the substitute flash memory package based on the attribute of the relevant block.

2. The storage apparatus according to claim 1, wherein the leveling processing unit is constituted from a storage controller connected via a network to a host,
wherein the storage controller judges write access frequency of data in each block of the plurality of flash memory packages according to a microcode program, gives a high access attribute to a block including high access frequency data, and gives a low access attribute to a block including low access frequency data, and
wherein when the real flash memory packages lack free blocks and devices belonging to any of the real flash memory packages and the substitute flash memory package are selected as the leveling object devices, if the attribute of a block in the real flash memory packages belonging to the leveling object devices is the high access attribute, data larger than a threshold value from among the data belonging to that block is migrated to a block in the substitute flash memory package; or
if the attribute of a block in the real flash memory packages belonging to the leveling object devices is the low access attribute, data smaller than the threshold value from among the data belonging to that block is migrated to a block in the substitute flash memory package.

3. The storage apparatus according to claim 1, wherein the leveling processing unit measures write access frequency of data in each block of the plurality of flash memory packages, and gives a high access attribute to a block containing data whose measured value of the write access frequency is larger than a threshold value, or gives a low access attribute to a block containing data whose measured value of the write access frequency is smaller than the threshold value; and when devices belonging to any of the real flash memory packages and the substitute flash memory package are selected as the leveling object devices, if the attribute of a block in the real flash memory packages belonging to the leveling object devices is the high access attribute, data larger than the threshold value from among the data belonging to that block is migrated to a block in the substitute flash memory packages.

4. The storage apparatus according to claim 1, wherein the leveling processing unit measures write access frequency of data in each block of the plurality of flash memory packages, and gives a high access attribute to a block containing data whose measured value of the write access frequency is larger than a threshold value, or gives a low access attribute to a block containing data whose measured value of the write access frequency is smaller than the threshold value; and when devices belonging to any of the real flash memory packages and the substitute flash memory package are selected as the leveling object devices, if the attribute of a block in the real flash memory packages belonging to the leveling object devices is the low access attribute, data smaller than the threshold value from among the data belonging to that block is migrated to a block in the substitute flash memory package.

5. The storage apparatus according to claim 1, wherein the plurality of flash memory packages include a flash memory adapter for controlling access to data in the plurality of flash memories, wherein the flash memory adapter serving as a substitute for the leveling processing unit manages data in each block of the plurality of flash memory packages based on the attribute of the relevant block and executes leveling processing on data in blocks belonging to the leveling object devices.

6. The storage apparatus according to claim 1, wherein the leveling processing unit is connected via a network to a management console and gives, to each block in the plurality of flash memory packages, an attribute indicating the property of data belonging to the relevant block based on instruction information from the management console.

7. The storage apparatus according to claim 1, wherein the leveling object devices are column devices constituted from a plurality of physical devices that forms a logical storage area for the flash memories belonging to the plurality of flash memory packages, or a plurality of logical devices formed across the column devices.

8. A data control method for a storage apparatus including:
a plurality of flash memory packages mounted on a chip, including real flash memory packages that are already set as flash memory packages containing a plurality of flash memories in which block groups (BLK), data memory units, are formed, and a substitute flash memory package that is a substitute for the real flash memory packages; and
a leveling processing unit for managing data in each block of the plurality of flash memory packages based on the attribute of the relevant block and executing leveling processing on data in blocks belonging to at least one leveling object device from among devices constituting the plurality of flash memory packages;
the data control method comprising a step executed by the leveling processing unit of migrating data in a block of the real flash memory packages belonging to the leveling object device to a block in the substitute flash memory package based on the attribute of the relevant block.

9. The storage apparatus data control method according to claim 8, further comprising the steps executed by the leveling processing unit of:
measuring write access frequency of data in each block of the plurality of flash memory packages;
giving a high access attribute to a block containing data whose measured value of the write access frequency is larger than a threshold value, or gives a low access attribute to a block containing data whose measured value of the write access frequency is smaller than the threshold value; and
when devices belonging to any of the real flash memory packages and the substitute flash memory package are selected as the leveling object devices, and if the attribute of a block in the real flash memory packages belonging to the leveling object devices is the high access attribute, migrating data, which is larger than the threshold value from among the data belonging to that block, to a block in the substitute flash memory package.

10. The storage apparatus data control method according to claim 8, further comprising the steps executed by the leveling processing unit of:
measuring write access frequency of data in each block of the plurality of flash memory packages;
giving a high access attribute to a block containing data whose measured value of the write access frequency is larger than a threshold value, or gives a low access attribute to a block containing data whose measured value of the write access frequency is smaller than the threshold value; and
when devices belonging to any of the real flash memory packages and the substitute flash memory package are selected as the leveling object devices, and if the attribute of a block in the real flash memory packages belonging to the leveling object devices is the low access attribute, migrating data, which is smaller than the threshold value from among the data belonging to that block, to a block in the substitute flash memory package.
